(19) United States
(12) Patent Application Publication
(10) Pub. No.: US 2003/0033418 A1
(43) Pub. Date: Feb. 13, 2003

(54) Method of implementing and configuring an MGCP application layer gateway

(76) Inventors: Bruce Fitzgerald Young, San Jose, CA (US); Eric Hilton Nielsen, Santa Cruz, CA (US); David Mitchell Hurwit, Mountain View, CA (US)

Correspondence Address: Pyong Yoon, Fried, Frank, Harris, Shriver & Jacobson, 1001 Pennsylvania Avenue, NW, Suite 800, Washington, DC, 20004, US

(21) Appl. No.: 10/200,020

(22) Filed: Jul. 19, 2002

Related U.S. Application Data
(60) Provisional application No. 60/307,004, filed on Jul. 19, 2001.

(51) Int. Cl. G06F 15/16

(52) U.S. Cl. 709/230

(57) ABSTRACT

The invention provides methods and systems using a Media Gateway Control Protocol (MGCP) Application Layer Gateway (ALG) for delivery of VoIP packets to Internet Protocol (IP) phones and to client adapters (CA). The invention provides a customer premises device acting as a proxy between a single Wide Area Network (WAN) Extranet IP address and any number of MGCP client adapters and MGCP phones. To act as a proxy, the MALG parses MGCP signaling packets and opens communications ports as required to deliver VoIP. The MGCP ALG (MALG) registers MGCP phones and identifies required service parameters. The MALG represents all registered MGCP phones to the Extranet via its single public WAN IP address. The MALG is integrated into premises networks via flexible multi-port LAN connections. The MALG can connect to existing premises networks via multiple configuration options. These options are part of the unique MALG capabilities.

### RELATED APPLICATION

This application is related to and claims priority from the U.S. Provisional Application No. 60/307,004 titled, “A Method of Implementing and Configuring an MGCP Application Level Gateway,” filed on Jul. 19, 2001.

### FIELD OF THE INVENTION

This invention relates to a communication system within a customer premise implementing Media Gateway Control Protocol (MGCP) translation for customer premises phone systems in order to support voice delivered over the Internet Protocol (VoIP).

### BACKGROUND OF THE INVENTION

Voice delivery systems in prior art were designed for the synchronous transmission of analog voice signals between subscriber locations and a central office. Today, data is largely delivered in digital form over shared access packet delivery systems dependent upon the Internet Protocol (IP). As a result, voice communication is now available over IP networks.

Since Customer Premises Equipment (CPE) is usually connected to a private Local Area Network (LAN), the CPE obtains private (LAN) IP addresses, either statically or via Dynamic Host Control Protocol (DHCP), for communicating over the LAN. In order to transmit data from or to the LAN from a public Wide Area Network (WAN), such as the Internet, a Network Address Translation (NAT) process is required to translate private (LAN) IP addresses to and from public (WAN) IP addresses.

Unlike many other types of data communication protocols, the MGCP, contains session descriptor protocol to dynamically open ports in order to transmit and receive media, such as voice. MGCP manages signaling and control interfaces between IP network switching and end point devices. In particular, MGCP signals to open ports for Real-time Transport Protocol (RTP) media bearing voice data.

Real problems arise in an MGCP-based system from the deployment of IP phones with private IP addresses. These devices dynamically spawn communication streams identified by port numbers. For each voice call, two Open Logical Channels (OLC) are established to transfer RTP media via UDP ports. Because they are dynamically opened and closed, these port numbers are unknown to the NAT/router. NAT does not parse MGCP signaling packets to and from VoIP phones and will not open ports for RTP media communication. The current alternative is to apply one public WAN IP address to each VoIP device. Because of a shortage of public addresses, often this is not practical, can be difficult to maintain and provides little or no security to the VoIP devices.

The present invention, the MALG (Media Gateway Control Protocol (MGCP) Application Layer Gateway (ALG)) provides a dynamic ALG with a single public (WAN) IP address between VoIP phone private (LAN) IP addresses and the Extranet; that is, the Internet or some other WAN. It then acts as a proxy to any number of IP phones on a private segment. As a proxy, the MALG directs all VoIP communication over dynamically-opened ports to the respective VoIP devices.

### SUMMARY OF THE INVENTION

A glossary of terminologies frequently used herein is set forth in Appendix A hereto. The present invention provides a CPE device which can serve as a proxy between a single Extranet WAN IP address and any number of MGCP enabled IP phones. The MALG serves any number of MGCP phones with private LAN IP addresses over one public WAN IP address. Thus, the MALG can serve as a WAN-accessible proxy for any number of private MGCP phones. The MALG transparently maps MGCP phone private IP addresses into its public IP address and supplies the address translation. Hence, the MALG includes a distinct set of novel capabilities that significantly simplify VoIP communications in a secure way.

The MALG registers MGCP phones and represents them to the Extranet via its single public IP address. During MGCP call setup signaling, the MALG replaces MGCP packet private IP addresses with its public IP address and the private Transaction ID with a public Transaction ID, then transmits the packet over a public User Datagram Protocol (UDP) port number. By parsing MGCP packets, the MALG identifies Session Description Protocol (SDP) type fields and opens UDP ports to carry RTP voice media. The MALG receives and dynamically establishes communication paths on these UDP ports. Subsequent RTP packets delivered to these UDP ports are relayed to the corresponding private IP address of the corresponding IP phone. When a call ends, the MALG closes the corresponding UDP ports and frees those ports for reuse. The specific processes utilized by the MALG are shown in FIGS. 7-11 and are discussed in detail below.

The MALG can connect to existing networks, with a combination of routers, firewalls and private segments, via multiple configuration options as shown in FIGS. 2-5. These configuration options which are part of the unique MALG capabilities, will be discussed in detail below.

### BRIEF DESCRIPTION OF THE DRAWINGS

There are shown in the drawings certain exemplary embodiments of the invention as presently preferred. It should be understood that the invention is not limited to the embodiments disclosed as examples and can be implemented through variations within the scope of the appended claims.

FIG. 1: shows a typical customer premise network of the prior art, without an MALG.

FIG. 2: shows an MALG configured on a LAN behind a firewall.

FIG. 3: shows an MALG spanning a firewall.

FIG. 4: shows an MALG configuration with a private voice segment.

FIG. 5: shows an MALG separating voice and data WAN traffic.

FIG. 6: shows signaling and call flow through a MALG.

FIG. 7: shows the functional architecture of an MALG.

FIG. 8: is a detailed flow diagram showing packet flow through an MALG.

FIG. 9: is an exemplary flow diagram showing the overall MALG processing of MGCP packets including SDP fields and RTP packets.

FIG. 10: is an exemplary flow diagram showing the processing of SDP fields of MGCP packets.

FIG. 11: is an exemplary flow diagram showing the processing of RTP packets.

### DETAILED DESCRIPTION OF THE PREFERRED EMBODIMENTS

For convenience, the description comprises five sections: I. Brief summary of the MALG system and processes; II. Multiple MALG configurations; III. MALG Processes including call signaling, media signaling and media transport; IV. Optional MALG features; and V. MGCP Application Layer Gateway proxy example.

I. Brief Summary of the MALG System and Processes

The MALG serves any number of MGCP enabled IP phones with one private LAN IP address and one public WAN IP address. Thus, the MALG can serve as a WAN-accessible proxy for any number of private MGCP phones. The MALG maps MGCP phone private IP addresses into its public WAN IP address and supplies the address translation for MGCP signaling and Real-time Transport Protocol (RTP), as well as Real-time Transport Control Protocol (RTCP) media communications.

The MALG also maps the IP Universal Resource Identifier (URI) phone ID to its public IP address. If an IP phone changes its private IP address, public servers will not need to be aware of this change since the public servers are only aware of the MALG public IP address.

MGCP phones on a LAN can be configured such that the MALG is their call control server. Optionally, MGCP phones on a LAN can be configured such that the MALG is their Network Time Protocol (NTP) server, and their File Transfer Protocol (FTP) or Trivial File Transfer Protocol (TFTP) boot server. As a result, the MGCP phone registration process is simplified, since the MALG can act as a local registration point and as a relay for services, such as downloading IP phone software. The MALG masquerades as if it were the call control server. Unlike a control server, however, the MALG does not keep the call state (status of all of the MGCP packets) except to determine when and how to map voice-related RTP streams from the LAN to the public WAN. All RTP media streams designated for WAN transmission are also masqueraded by the MALG and forwarded using the MALG WAN IP address. That is, the MALG has a public routable WAN IP address communicating with Extranet routers, switches and gateways, and is a proxy for private IP phone addresses.

The MALG allows IP phones to be distributed across multiple subnets. In this context, VoIP private IP addresses are no different than the addresses of other network equipment. Additionally, multiple MALG devices can be used in parallel for incremental expansion.

II. Multiple MALG Configurations

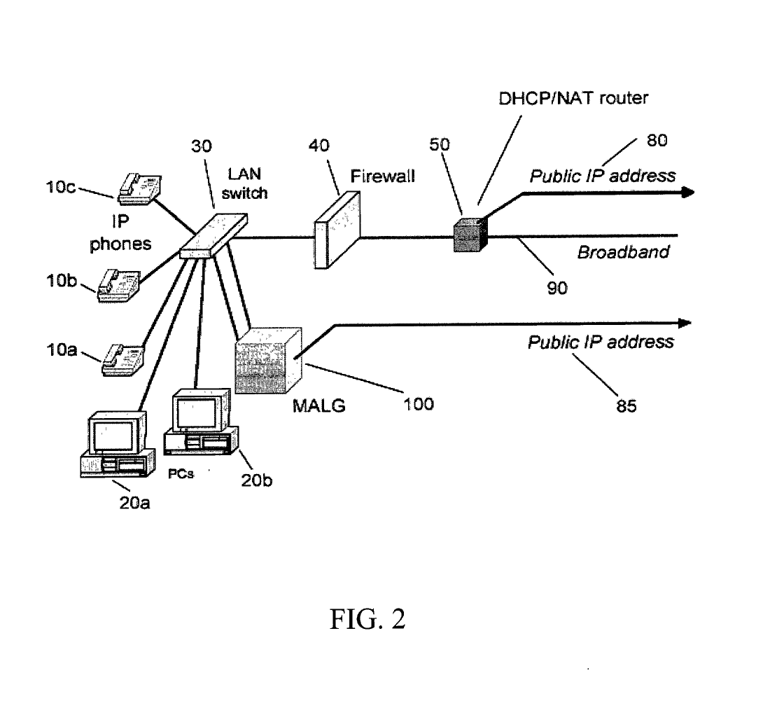

With multiple configuration options the MALG can be used to complement existing network equipment containing a combination of NAT, routers, firewalls and private segments. Multiple configurations make the MALG adaptable to a variety of existing CPE data networks (such as those shown in FIGS. 2-5). By acting as a VoIP proxy, each MALG supports any number of MGCP phones with private IP addresses independent of how the MGCP phone obtained its IP address.

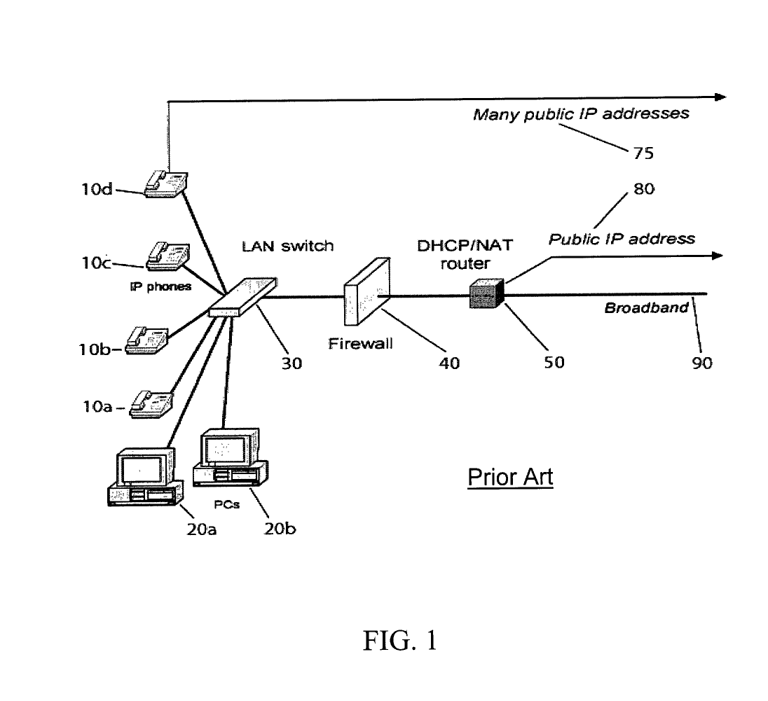

In the typical prior art broadband 90 network shown in FIG. 1, the IP phones 10a, 10b, 10c, 10d and the computers 20a, 20b are connected to the LAN switch 30. The LAN switch 30 is connected to the firewall 40, which is in turn coupled to the DHCP/NAT router 50. This DHCP/NAT router 50 does not parse MGCP signaling packets to and from VoIP phones and will not open ports for RTP media communication. As shown in this prior art, four public IP addresses 75 are required for the four IP phones 10a, 10b, 10c, 10d. In other words, one public WAN IP address is required for each VoIP device.

Referring now to the broadband 90 network shown in FIG. 2, which integrates the MALG of the present invention, the IP phones 10a, 10b, 10c and the computers 20a, 20b are connected to the LAN switch 30. In this configuration, the MALG 100 is deployed behind an existing firewall 40, the outgoing MALG WAN IP address 85 is accessible from the WAN through the DHCP/NAT router 50, the firewall 40 and the LAN switch 30. In order to access the MALG through the firewall 40, the firewall 40 must be configured with a static open UDP port range (pinholes) allowing inbound VoIP traffic to pass to the MALG WAN IP address 85. The set of static open UDP ports are used for MGCP, RTP and RTCP communications. During each voice session, RTP ports within the range of open ports are dynamically bound to transfer voice media to a corresponding MGCP phone served by a MALG 100. The IP phones 10a, lob, 10c and the computers 20a, 20b with VoIP soft phone capability, are examples of MGCP phones.

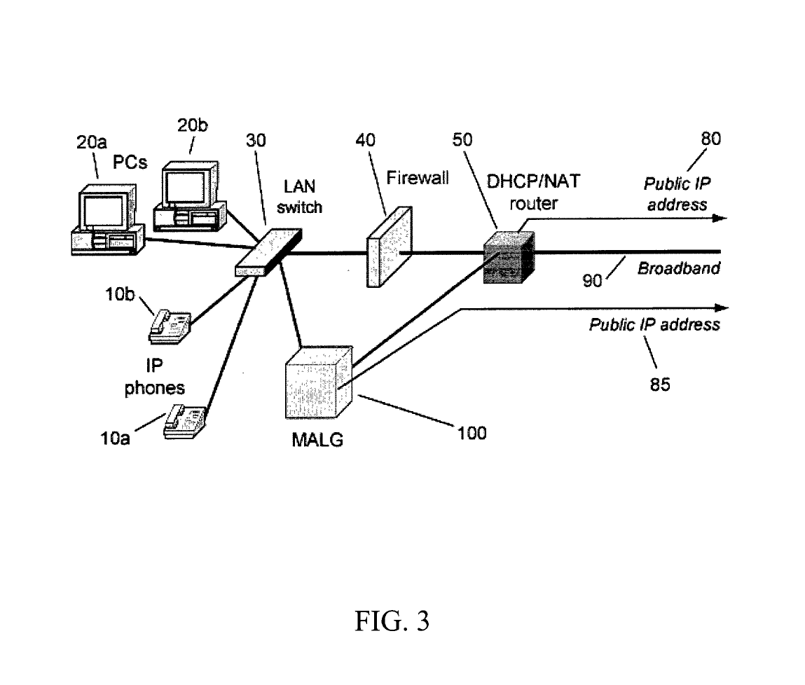

In the configuration shown in FIG. 3, the MALG 100 is positioned so it spans the firewall 40. An MALG 100 with dual Ethernet ports can be used in this configuration. Similar to the configuration shown in FIG. 2, the IP phones 10a, 10b and the computers 20a, 20b are connected to the LAN switch 30. However, the MALG 100 spans, or bypasses, the firewall 40, and directly connects to the LAN switch 30 and the DHCP/NAT router 50. In this configuration, MGCP signaling and RTP VoIP traffic is diverted from passing through the firewall 40. Thus, the firewall 40 does not open UDP ports for MGCP, RTP or RTCP packets.

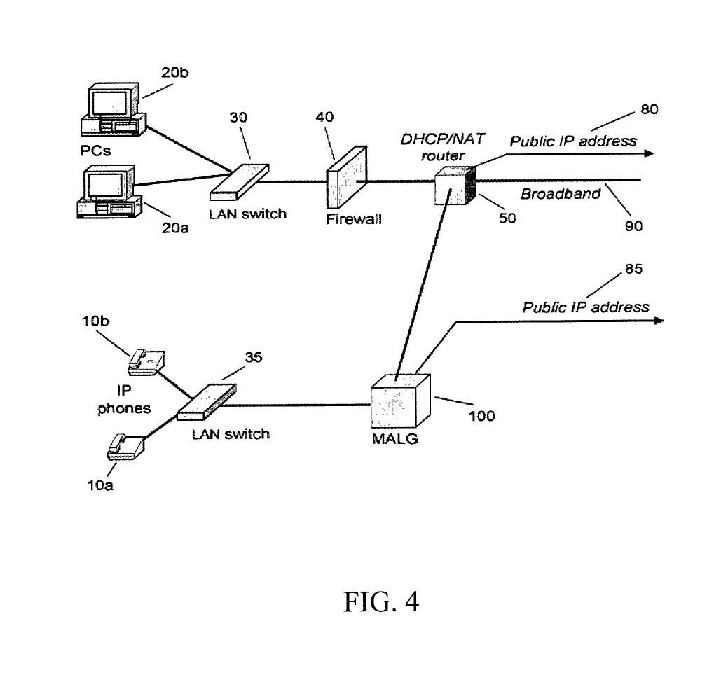

In the configuration shown in FIG. 4, the MALG 100 can serve a voice-only LAN segment 35. In this configuration, the voice traffic will not compete with data traffic on the same LAN. The data traffic from the computers 20a, 20b flows through a LAN switch 30 connected to the firewall 40, which is in turn coupled to the DHCP/NAT router 50. In contrast, the voice traffic from the IP phones 10a, 10b is processed by the MALG 100 and the DHCP/NAT router 50 through a separate voice-only LAN switch 35. Similar to the configuration in FIG. 3, the MGCP signaling and RTP VoIP traffic is diverted from the firewall 40, and thus the firewall 40 does not open UDP ports for MGCP, RTP or RTCP packets.

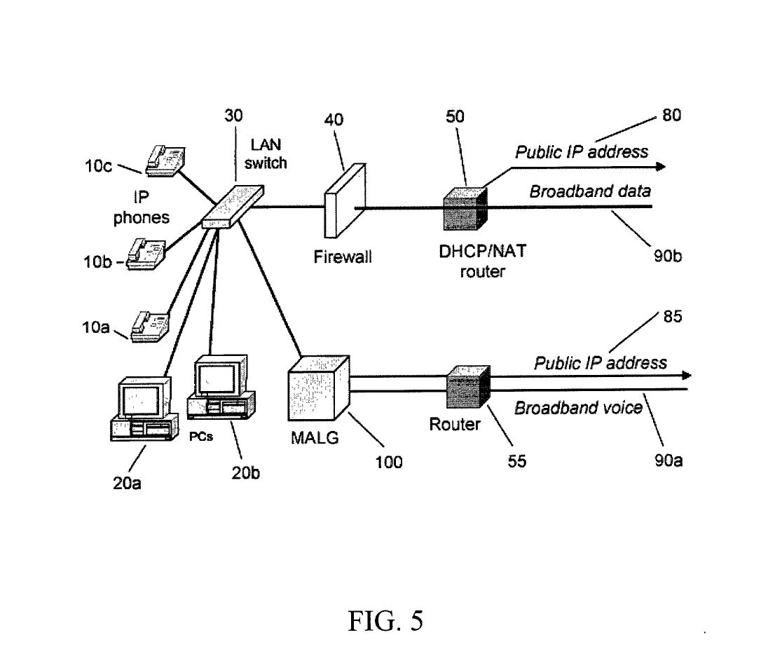

In yet another configuration shown in FIG. 5, the MALG 100 can route all voice traffic to a specific router 55 on a separate broadband 90a. The MALG 100 does not contend for bandwidth with other data applications over this voice-only WAN broadband 90a. The IP phones 10a, 10b, 10c and the computers 20a, 20b are connected to the LAN switch 30. In this configuration, the data traffic from the computers 20a, 20b flows through the LAN switch 30 connected to the firewall 40, which is in turn coupled to the DHCP/NAT router 50. Although the voice traffic from the IP phones 10a, 10b, 10c is processed through the same LAN switch 30, it flows through the MALG 100 and router 55 versus the firewall 40 and DHCP/NAT router 50.

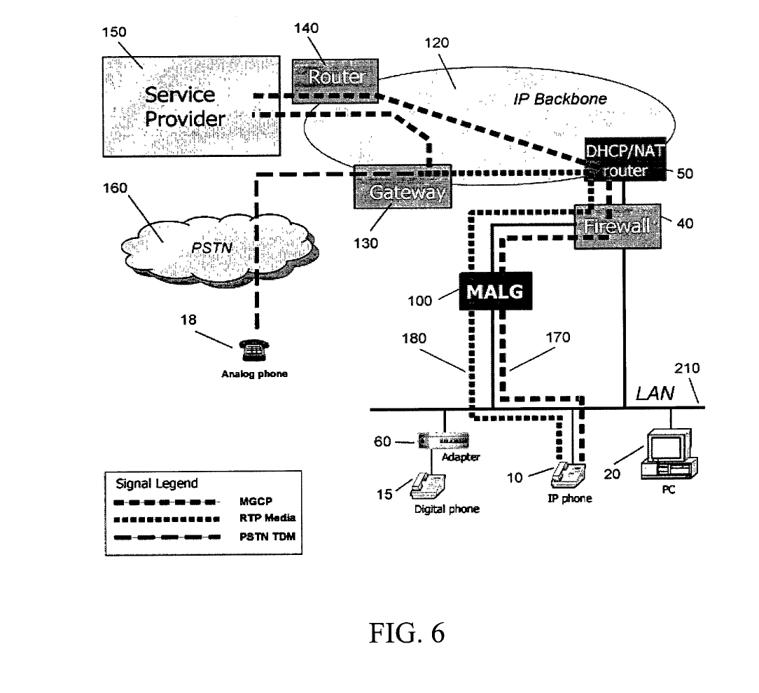

Referring now to FIG. 6, an exemplary network system shows signaling and call flow through an MALG 100. On the MALG LAN side 210, one or more IP phones 10, attached computers 20, and client adapters 60, such as a Sylantro CA-224 (which can support 24 CPE phones), are supported by a single MALG 100. Client adapters 60 typically have one physical LAN port with one IP address. The client adapter 60 can also serve as a proxy to one or more analog and/or digital phones 15.

As shown in FIG. 6, from the LAN 210, MGCP signaling 170 and RTP media 180 flow from the IP phone 10 and IP adapter 60 through the MALG 100 and then on the WAN side, to firewall 40 and DHCP/NAT router 50. From the DHCP/NAT router 50 the MGCP signaling 170 flows via the IP backbone 120 through another router 140 to a service provider 150 and is directed to a gateway 130 where MGCP signaling is converted to PSTN 160 legacy signaling to telephone 18, which is a traditional analog device; that is, a “black phone”. The RTP media 180, after being addressed by the MALG 100, flows through firewall 40 and DHCP/NAT router 50 to a gateway 130, where they are converted to PSTN TDM signals 190 and transmitted via the PSTN 160 to the end device 18.

III. MALG Processes including Call Signaling, Media Signaling and Media Transport

The MALG registers MGCP phones and represents them to the Extranet via its single public WAN IP address. During MGCP call setup signaling, the MALG replaces MGCP packet private IP addresses with its public IP address and a known User Datagram Protocol (UDP) port number. Using Session Description Protocol (SDP) signaling packets, MGCP opens and closes UDP ports to carry Real-time Transport Protocol (RTP) or Real-time Transport Control Protocol (RTCP) voice media packets. The MALG receives and dynamically establishes communication paths on these UDP ports. Subsequent RTP packets delivered to these UDP ports are relayed to the corresponding private IP address of the corresponding IP phone.

MALG processes, rewrites and forwards MGCP call signaling, SDP media signaling and RTP and RTCP media transport packets. Each of these processes is explained below.

A. Call Signaling: MGCP Header Rewriting and Forwarding

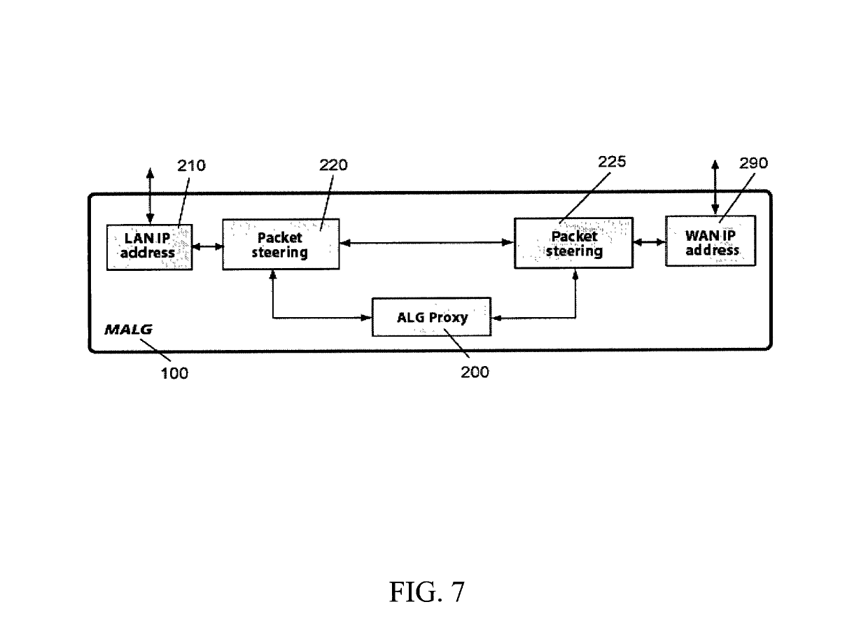

As shown in FIG. 7, in a preferred embodiment of the present invention, the MALG accepts MGCP packets on its LAN 210 or WAN 290 IP addresses using static LAN and WAN UDP ports. The MALG inspects and steers all MGCP packets via packet steering 220, 225, such that outbound packets received from the LAN are steered to the ALG proxy 200, which replaces the private VoIP phone LAN 210 IP address within the MGCP header with the MALG WAN 290 IP address. Similarly, for inbound packets received from the WAN 290, the MALG ALG proxy 200 replaces its own WAN IP address within the MGCP header with the appropriate VoIP phone LAN 210 IP address. This address translation is needed when IP phones are using private IP addresses. In the process of scanning packets, the mapping of IP phone addresses to host names is automatically learned and stored indefinitely by the MALG. If an IP phone appears with a new IP address but its original host name, the new IP address will be learned and the old IP address ignored.

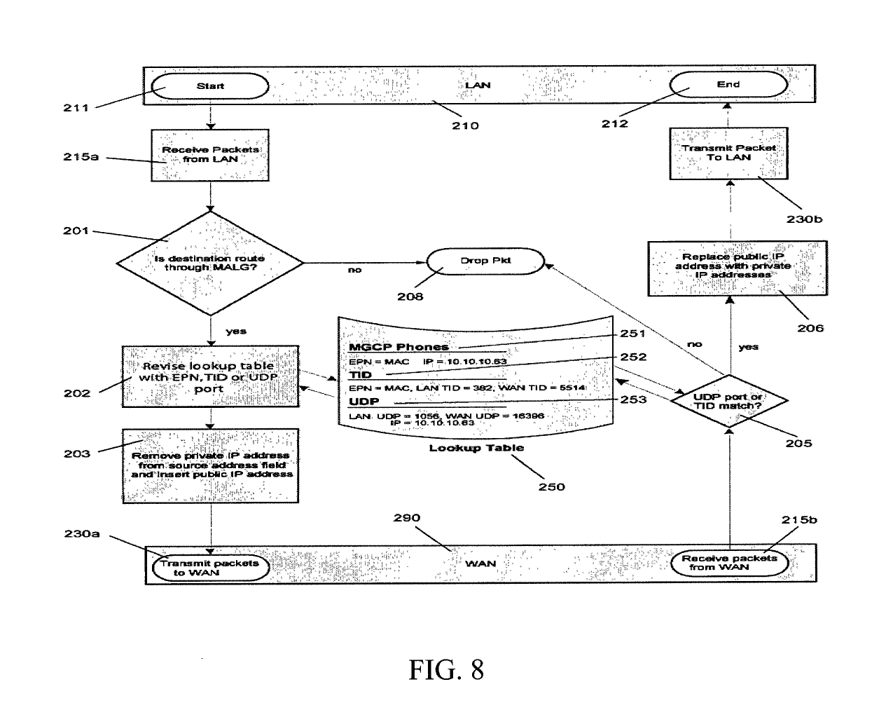

FIG. 8 shows a typical MGCP packet-flow through the MALG, with particular emphasis on the operation of the ALG proxy 200 of FIG. 7. Starting with step 211 at the LAN 210, the MALG receives an MGCP packet from the LAN, step 215a, and determines whether the packet's destination is through the WAN port, step 201. If so, then the MALG assigns a new public Transaction ID (TID). The source IP phone Endpoint Name (EPN), the private TID number and the public TID 252 are stored in the lookup table 250. Then the private (LAN) IP address, from the source-packet address field, is replaced with the MALG public (WAN) IP address, the private TID is replaced with the public TID, step 203, and the processed packet is transmitted to the WAN, step 230a. Packets not destined for the WAN are dropped, step 208, because the MALG only transmits packets between the LAN and WAN interfaces.

As shown in FIG. 8, the MALG similarly receives an MGCP packet from the WAN, step 215b and determines whether the public TID number, step 205 is in the lookup table 250. If so, the destination WAN IP address, the public destination UDP port and the public TID are replaced, step 206, with the IP phone destination LAN IP address, the private destination UDP port and the private TID 252, respectively. Also, the source IP address and the source UDP port, from the source address field, are replaced with the MALG source LAN IP address and source UDP port. Then, the packet is transmitted to the LAN, step 230b. If the packet's public TID number 252 is not in the lookup table 250, then the packet is dropped, step 208, because it cannot be delivered to an IP phone on the LAN.

B. Media Signaling: SDP Rewriting

Every inbound and outbound MGCP packet is parsed for a Session Description Protocol (SDP) field. A SDP field designates new UDP ports for communicating RTP media. One RTP port, inbound or outbound, is contained in each SDP request. By parsing SDP fields in the MGCP packets, the MALG dynamically opens the UDP ports to start RTP communication.

For an outbound MGCP packet with an SDP field type, an MALG WAN UDP port number is opened and is stored with the IP phone source IP address and UDP port information 253 in the ALG lookup table 250 as illustrated in FIG. 8, such that subsequent RTP packets will be received on the MALG WAN IP address at the new WAN UDP port number and forwarded to the source IP phone LAN IP address and UDP port number.

For an inbound MGCP packet with an SDP field type, the MALG opens the requested UDP port on its WAN IP address and opens a new UDP port on the MALG LAN side, then the MALG stores the UDP port information with the destination phone IP address 253 in the ALG lookup table 250 such that subsequent RTP packets will be received on the MALG WAN IP address at the requested WAN UDP port number and forwarded to the destination phone LAN IP address and new UDP port number. This inbound MGCP packet is then forwarded according to the MGCP signaling procedure in the proceeding Section A.

For each of the MALG LAN and WAN IP addresses, the MALG maintains a map of corresponding IP addresses, public TID and ports that are receiving and transmitting MGCP, RTP or RTCP packets and how those packets are forwarded by the opposite MALG IP address interface. This mapping is dynamic and time sensitive; i.e., the ports and IP address table must be revised and ready to transmit RTP or RTCP packets within 10 ms of receipt of each MGCP signaling packet with an SDP field type.

C. Media Transport: RTP and RTCP Forwarding

As the MALG makes the modifications to the SDP field, it opens the appropriate UDP port and forwards all packets to that port out the other interface (LAN or WAN) to the appropriate destination. RTP or RTCP packets are forwarded according to the map built by the SDP rewrite process. As packets are scanned, any changes to the connection must also be reflected in the RTP or RTCP forwarding map 253 of lookup table 250. Also, if a connection sees no data for a period of time, usually about 20 seconds, then the forwarding port map should be removed. The MALG requires that a range of UDP ports be reserved for exclusive use by the MALG. The typical range of open UDP ports is up to two times the maximum number of simultaneous calls (e.g., one RTP+one RTCP ports per call) the MALG is able to process.

IV. Optional MALG Features: FTP, TFTP and NTP Relay and Multiple Ports

A. IP phone Configuration: FTP and TFTP Relay/Server

MGCP IP phones require software image download from a well known port of a trusted server, such as the FTP or TFTP port. The IP address of the FTP or TFTP server is configurable in the IP phone and points to an external server, to the MALG or to another server with a private IP address. The MALG can optionally act as a FTP or TFTP relay to forward download images to IP phones. Optionally, the MALG can store software images and act as a TFTP or FTP server to the IP phones. Alternately, MGCP IP phones may access another server with a private IP address directly for TFTP or FTP service. When the MALG serves or relays FTP or TFTP, the IP phone requests the image download, the MALG recognizes this request and provides the download directly or via transfer from an external server.

B. IP phone Configuration: NTP Relay/Server

Most MGCP IP phones must periodically access and display the time of day. The MALG can act as a Network Time Protocol (NTP) relay for MGCP IP phones. When providing NTP to IP phones, the MALG must to be configured to use NTP from an external time source. When the MALG relays NTP, the IP phone requests the time and the MALG recognized this request and provides time from the external server.

C. Multiple WAN and LAN Ports

An exemplary MALG system may have one or two physical LAN connectors attached to the MALG LAN and WAN logical IP addresses. The MALG in FIG. 2 may present both LAN and WAN logical IP addresses on one physical LAN connector. In FIG. 3, except where the LAN switch 30, the firewall 40 and the DHCP/NAT router 50 are one device, the MALG must present a LAN IP address on one physical connector and a WAN IP address on a second physical connector.

In FIG. 4 and FIG. 5, the MALG must present a LAN IP address on one physical connector and a WAN IP address on a second physical connector.

V. MGCP Application Layer Gateway Proxy Example

An exemplary use of the MALG system is where the MALG serves as a call control proxy/Application Layer Gateway (ALG) for IP voice and multimedia protocols supported by Media Gateway Control Protocol (MGCP) signaling and call management. FIGS. 8-11 are exemplary flow diagrams showing the overall MALG processing of MGCP packets including SDP fields and RTP packets. For definitions of standard industry terminologies such as SA (Source Address), DA (Destination Address), SP (Source Port), DP (Destination Port), etc., the MGCP RFC 2705 standard (M. Arango, et. al. “Media Gateway Control Protocol,” Request for Comments 2705, Internet Engineering Task Force, October 1999) is incorporated herein by reference.

A. IP Phone Registration

First, in FIG. 6, VoIP phones 10 and client adapters 60 are configured to point to the MALG 100 as the call control server, proxy, gatekeeper or gateway. Typically, the IP address of a call control server, proxy, gatekeeper or gateway, is programmed into the IP phone 10 through a menu on the phone or through FTP, TFTP or other remote configuration mechanisms. In this example, the LAN IP address of the MALG 100 is programmed into the IP phone 10 in place of the actual call control server, proxy, gatekeeper or gateway IP address.

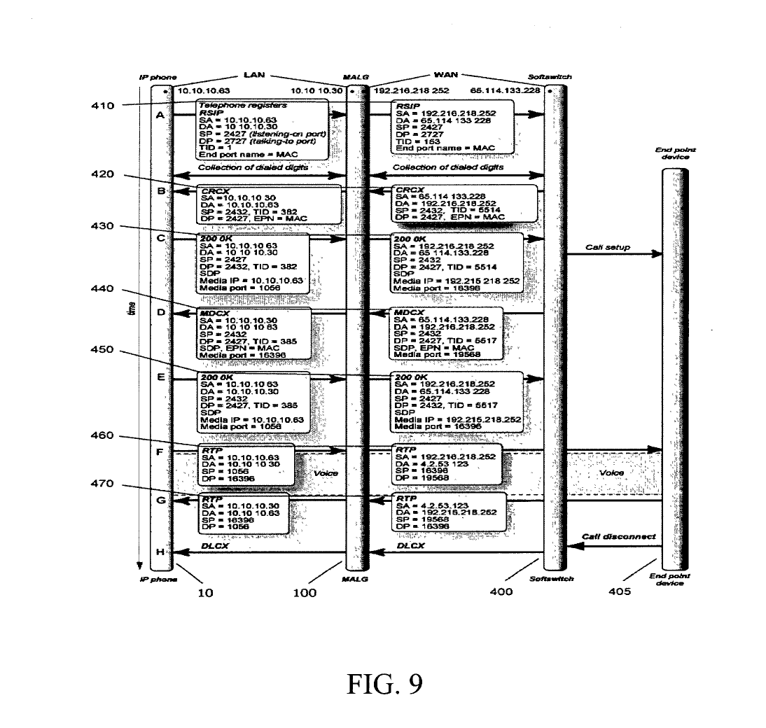

When an IP phone initiates any MGCP communication, those MGCP packets are sent to the MALG LAN IP address. The MALG listens for RSIP messages, packet A 410 of FIG. 9, registering IP phones on pre-defined UDP port 2727. The MALG receives packets on UDP port 2727 and registers the new MGCP IP phone by updating its MGCP client list section 251 of table 250 of FIG. 8 with the IP phone Line ID, URI (Uniform Resource Identifier) or endpoint name (EPN) and the phone private IP address.

The MALG replaces the phone IP address with its WAN IP address and forwards those packets to the respective external call control server. Thus, the MALG masquerades by registering as an IP phone to the call control server. The call control server does not need to know the private IP addresses or the phone's UDP port numbers of IP phones served by the MALG. Instead, the MALG acts as an MGCP signaling proxy for MGCP IP phones.

B. MGCP Signaling

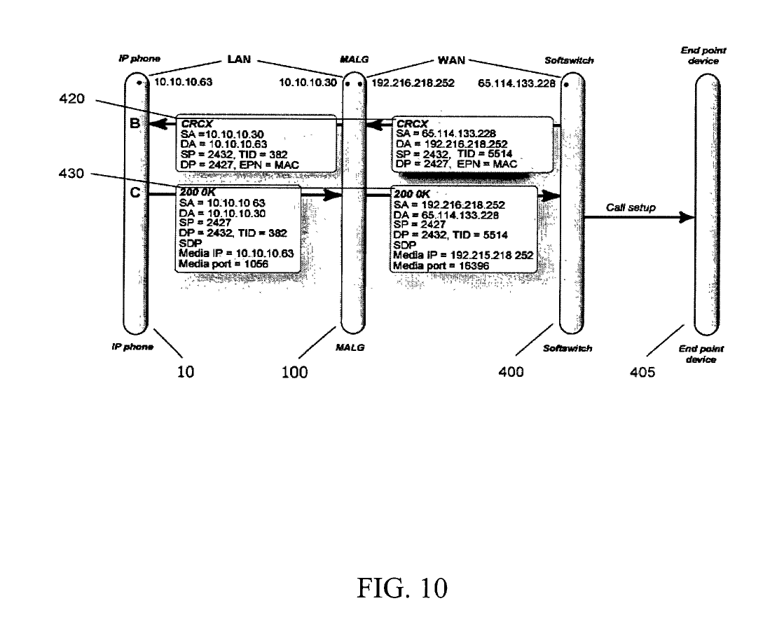

FIG. 8 illustrates the process flow of MGCP packets from a LAN via an MALG 100 to a WAN and then via a softswitch 400 to an endpoint device 410. To make calls, the IP phone 10 of FIG. 6 issues a sequence of MGCP signaling packets. An incoming call directed toward an IP phone 10 of FIG. 6, issues a similar set of MGCP signaling packets. A typical call includes about thirty (30) MGCP packets. Each call has a unique session ID, shown in FIG. 10 packet B 420 as Session ID=1234. Each set of MGCP request and response packets uses the same TID, shown in FIG. 10 packet B 420 as LAN TID=382 and WAN TID=5514.

All IP phones transmit and receive on pre-defined ports; for the example in FIG. 9 the IP phones use UDP port 2427. The MALG transmits and listens on pre-defined LAN UDP port 2727 for IP phone registration and on pre-defined LAN port 2432 for MGCP signaling, shown in FIG. 9.

Each MGCP exchange of requested and acknowledged services has a unique Transaction ID (TID) for a specific sequence of packets transported between the IP phone 10 and the softswitch 400 via the MALG 100 of FIG. 9. The transaction ID is shown in FIG. 9 packet B 420 as TID=382. The TIED changes with each MGCP exchange within a signaling session. The Session ID does not change until a new call is initiated.

As shown in FIG. 9, the MALG receives MGCP packets from the WAN and from the LAN on UDP port 2427.

C. Packet Address Translation

FIG. 9 also illustrates the overall MALG processing of MGCP packets. All MGCP packets are parsed and forwarded through the MALG. As shown in FIG. 9, the MALG translates all MGCP packets, A through G, 410-470, of IP phone 10, between private IP phone address and the public WAN IP address.

Each set of MGCP request and response packets uses the same TID, shown in FIG. 9 and FIG. 10 packet B 420 as LAN TID=382 and WAN TID=5514. Packet B is sent by the softswitch to the MALG 100 WAN IP destination address (DA=192.216.218.252) on MGCP signaling port (DP=2427).

The MALG 100 parses packet B and confirms in the lookup table 250, section 251 of FIG. 8 that the TID 5514 corresponds to the LAN TID 382 for the IP phone with a specific EPN. From the lookup table 251 of FIG. 8, the MALG associates the phone private IP address (DA=10.10.10.63) with the IP phone EPN. The MALG 100 changes the softswitch source address (SA=65.114.133.228) to its LAN IP source address (SA=10.10.10.30) and changes its destination address (DA=192.216.218.252) to the IP phone destination address (DA=10.10.10.63) and changes the public TID 5514 to the private TID 382. Because they are statically allocated for MGCP communication, the UDP ports (SP=2432 and DP=2427) remain unchanged. The session ID is also unchanged. The MALG then forwards this MGCP packet to the corresponding IP phone in the destination address field.

Similarly, the MALG 100 forwards MGCP messages from IP phones 10 to the call control server.

The MALG parses each MGCP packet, finds the private TID in the lookup table 250, section 251 of FIG. 8. From the 251 of lookup table 250 of FIG. 8, the MALG changes the MALG LAN IP address (DA=10.10.10.63) to the softswitch destination address (SA=65.114.133.228) and changes the IP phone source address (SA=10.10.10.30) and to its WAN source IP address (SA=192.216.218.252) and changes the private TID 382 to the public TID 5514. Because they are statically allocated for MGCP communication, the UDP ports (SP=2432 and DP=2427) remain unchanged. The session ID is also unchanged. The MALG then forwards this MGCP packet to its WAN network interface.

D. SDP Field Types

Some of the MGCP packets effect changes in the lookup table 250, 253 of FIG. 8. This usually results when a connection is established between the source IP phone and a destination telephone. For each connection, independent media channels are created allowing the endpoints to communicate.

To open connections, MGCP packets include SDP fields signaling actions to open or close UDP ports for RTP voice and RTCP voice control packets.

As shown in FIG. 10, for example, Packet C 430 contains a 200 OK packet with an SDP field type. Packet C originates at the IP phone 10 (IP=10.10.10.63) with TID 382 and is sent to the MALG 100 (LAN IP=10.10.10.30) which acts as the switch proxy listening on MGCP signaling UDP port 2432. The SDP field in packet C, requests permission to read and write RTP packets on UDP media port 1056 for this call. The MALG 100 may use two different or the same UDP port number for subsequent LAN and WAN communication. For this case, the MALG assigns the port number 16396 on its LAN and WAN interfaces for subsequent RTP media transfer. The MALG 100 revises the section 253 of the lookup table 250 of FIG. 8 by mapping its IP phone UDP port 1056 to its LAN and WAN UDP ports 16396.

Then the MALG 100 simply replaces the phone IP address (SA=10.10.10.63), its destination LAN IP address (DA=10.10.10.30), the private TID 382 with WAN IP source address (SA=192.216.218.252), the softswitch 400 destination IP address (DA=65.114.133.228) and the public TID 5514. The session ID and the transaction ID remain unchanged. The MALG then forwards this MGCP packet to the corresponding IP phone in the destination address field.

E. RTP Voice Packets

As connections are opened for RTP streams, appropriate public or private IP addresses and UDP ports are used. For each call, two Open Logical Channels (OLCs) are established, one between a MALG LAN IP and a local IP phone 10 and the other between a MALG WAN IP and a remote device 410. The OLCs carry digital media produced by analog to digital CODECs, typically a G.711 or G.729 packet payload. To limit the number of UDP ports to be opened in an external firewall, the MALG 100 can be configured with a limited range of UDP ports available for use on its WAN interface. A typical range is two times the number of simultaneous calls (e.g., one RTP+one RTCP ports per call). Limiting the range of available UDP ports restricts the number of simultaneous calls supported by the MALG 100.

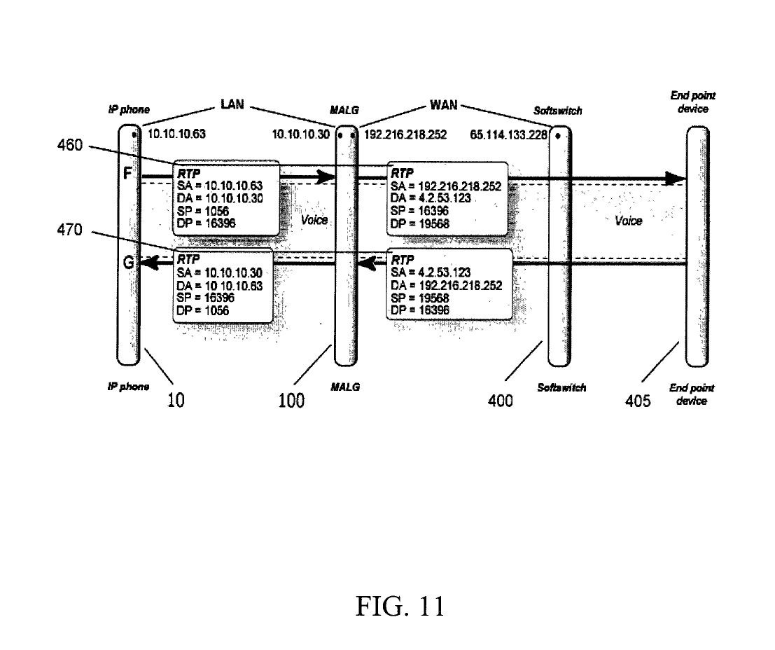

FIG. 11 illustrates the processing of RTP packets and demonstrates the detail of a MALG translating an RTP packet.

The RTP packet F 460 from IP phone port 1056 is received by the MALG on its LAN UDP port 16396. The MALG replaces the phone private IP address (IP=10.10.10.63) with its public WAN IP address (IP=192.216.218.252) and replaces source port 1056 with its WAN source port 16396. Since, for this call, source port 1056 is associated with destination port 19568, the MALG replaces destination port 16396 with destination port 19568.

The MALG receives packet G 470 on its WAN IP address, checks in the section 253 of the lookup table 250 of FIG. 8, and associates destination port 16396 with destination port 1056. The MALG changes the packet source address to its LAN IP address (SA=10.10.10.30) with the source port SP=16396. The MALG changes the destination address to the IP phone address (DA=10.10.10.63) with destination port DP=1056. The MALG then forwards this MGCP packet to the corresponding IP phone in the destination address field.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

[image]

[image]

[image]

[image]

[image]

[image]

[image]

[image]

[image]

We claim:

1. A method for processing at least one MGCP packet over a network, comprising the steps of:
receiving said at least one MGCP packet; and
mapping said at least one MGCP packet from a private IP address field to a public IP address field and a private TID number to a public TID number using an address lookup table.

2. A method for processing at least one MGCP packet over a network, comprising the steps of:
receiving said at least one MGCP packet; and
mapping said at least one MGCP packet from a public IP address field to a private IP address field and a public TID number to a private port TID number using an address lookup table.

3. The method of claim 1, wherein said mapping step comprises the steps of:
receiving said at least one MGCP packet from a LAN comprising said private IP address field;
storing said private IP address field and said private TID number in said address lookup table, and assigning said public TID number and inserting said public TID number into said address lookup table;
determining whether a destination route is through an MALG proxy, wherein if said destination route is not through said MALG proxy, then said at least one MGCP packet is dropped; and
wherein if said destination route is through said MALG proxy, then replacing said private IP address field with said public IP address field and replacing said private TID number with said public TID number, and transmitting said at least one MGCP packet to a WAN comprising said public IP address field.

4. The method of claim 2, wherein said mapping step comprises the steps of:
receiving said at least one MGCP packet from said WAN comprising said public IP address field;
storing said public IP address field and said public TID number in said address lookup table, and assigning said private TID number and inserting said private TID number into said address lookup table;
determining whether said public TID number and said mapped private TID number and said mapped private IP address field exists in said address lookup table, wherein if said public TID number or said mapped private TID number or said mapped private IP address field does not exist in said address lookup table, then said at least one MGCP packet is dropped; and
wherein if said public TID number or said mapped private TID number or said mapped private IP address field does exist in said address lookup table, then replacing said public IP address field with said private IP address field and replacing said public TID number with said private TID number, and transmitting said at least one MGCP packet to a LAN comprising said private IP address field.

5. A method for processing at least one MGCP packet over a network, comprising the steps of:
receiving said at least one MGCP packet;
mapping said at least one MGCP packet from a private IP address field to a public IP address field and a private TIED number to a public TID number using an address lookup table;
scanning said at least one MGCP packet to detect an SDP field wherein said SDP field includes at least one private UDP port number for receiving at least one RTP or RTCP packet from a LAN comprising said private IP address field and transmitting said at least one RTP or RTCP packet to a WAN comprising said public IP address field;
binding said private IP address field with said at least one private UDP port number included in said SDP field to a new private UDP port number selected by an MALG, and binding said public IP address field to a new public port number selected by said MALG such that said at least one RTP or RTCP packet can be received via said LAN comprising said private IP address field on said new private UDP port number, and is transmitted on said new public UDP port number via said WAN comprising said public IP address field, and said at least one RTP or RTCP packet can also be received via said WAN comprising said public IP address field on said new public UDP port number, and is transmitted on said new private UDP port number via said LAN comprising said private IP address field; and
unbinding said private IP address field with said at least one private UDP port number included in said SDP field from said new private UDP port number, and unbinding said public IP address field from said new public UDP port number such that said at least one RTP or RTCP packet is not transmitted on said new public and said new private UDP port numbers wherein said new public and said new private UDP port numbers are available for reuse.

6. A method for processing at least one MGCP packet over a network, comprising the steps of:
receiving said at least one MGCP packet
mapping said at least one MGCP packet from a public IP address field to a private IP address field and a public TID number to a private TID number using an address lookup table;
scanning said at least one MGCP packet to detect an SDP field wherein said SDP field includes at least one public UDP port number for receiving at least one RTP or RTCP packet from a WAN comprising said public IP address field and transmitting said at least one RTP or RTCP packet to a LAN comprising said private IP address field;
binding said public IP address field with said at least one public UDP port number included in said SDP field to a new public UDP port number selected by an MALG, and binding said private IP address field to a new private UDP port number selected by said MALG such that said at least one RTP or RTCP packet can be received via said WAN comprising said public IP address field on said new public UDP port number, and is transmitted on said new private UDP port number via said LAN comprising said private IP address field, and said at least one RTP or RTCP packet can also be received via said LAN comprising said private IP address field on said new private UDP port number, and is transmitted on said new public UDP port number via said WAN comprising said public IP address field; and
unbinding said public IP address field with said at least one public UDP port number included in said SDP field from said new public UDP port number, and unbinding said private IP address field from said new private UDP port number such that said at least one RTP or RTCP packet is not transmitted on said new private and said new public UDP port numbers wherein said new private and said new public UDP port numbers are available for reuse.

7. The method of claim 5 or 6, wherein said mapping step occurs within 10 milliseconds (ms) of receiving said at least one MGCP packet comprising at least one said SDP field.

8. The method of claim 5, wherein said mapping step comprises the steps of: receiving said at least one MGCP packet from a LAN comprising said private IP address field;
storing said private IP address field and said private TID number in said address lookup table, and assigning said public TID number and inserting said public TID number into said address lookup table;
determining whether a destination route is through an MALG proxy, wherein if said destination route is not through said MALG proxy, then said at least one MGCP packet is dropped; and
wherein if said destination route is through said MALG proxy, then replacing said private IP address field with said public IP address field and replacing said private TID number with said public TID number, and transmitting said at least one MGCP packet to a WAN comprising said public IP address field.

9. The method of claim 6, wherein said mapping step comprises the steps of:
receiving said at least one MGCP packet from said WAN comprising said public IP address field;
storing said public IP address field and said public TID number in said address lookup table, and assigning said private TID number and inserting said private TID number into said address lookup table;
determining whether said public TID number and said mapped private TID number and said mapped private IP address field exists in said address lookup table, wherein if said public TID number or said mapped private TID number or said mapped private IP address field does not exist in said address lookup table, then said at least one MGCP packet is dropped; and
wherein if said public TID number or said mapped private TID number or said mapped private IP address field does exist in said address lookup table, then replacing said public IP address field with said private IP address field and replacing said public TID number with said private TID number, and transmitting said at least one MGCP packet to a LAN comprising said private IP address field.

10. The method of claim 5 or 8, further comprising the step of mapping said at least one RTP or RTCP packet received from said LAN, comprising the steps of:
receiving said at least one RTP or RTCP packet from said LAN comprising said private IP address field;
storing said private IP address field and a private UDP port number in said address lookup table, assigning said public UDP port number and inserting said public UDP port number into said address lookup table;
determining whether a destination route is through an MALG proxy, wherein if said destination route is not through said MALG proxy, then said at least one RTP or RTCP packet is dropped;
determining whether said private UDP port number corresponding to said at least one RTP or RTCP packet exists in said address lookup table, wherein if said private UDP port number corresponding to said at least one RTP or RTCP packet does not exist in said address lookup table, then said at least one RTP or RTCP packet is dropped; and
wherein if said private UDP port number corresponding to said at least one RTP or RTCP packet does exist in said address lookup table, then replacing said private IP address field with said public IP address field and replacing said private UDP port number with said corresponding public UDP port number from said address lookup table, and transmitting said at least one RTP or RTCP packet to said WAN comprising said public IP address field.

11. The method of claim 6 or 9, further comprising the step of mapping said at least one RTP or RTCP packet transmitted to said WAN, comprising the steps of:
receiving said at least one RTP or RTCP packet from said WAN comprising said public IP address field;
storing said public IP address field and a public UDP port number in said address lookup table, and assigning a private UDP port number and inserting said private UDP port number into said address lookup table;
determining whether said public UDP port number and said private UDP port number and said private IP address exist in said address lookup table, wherein if said public UDP port number or said private UDP port number or said private IP address does not exist in said address lookup table, then said at least one RTP or RTCP packet is dropped; and
wherein if said public UDP port number or said private UDP port number or said private IP address does exist in said address lookup table, then replacing said public IP address field with said private IP address field, replacing said public UDP port number with said corresponding private UDP port number, and transmitting said at least one RTP or RTCP packet to said LAN comprising said private IP address field.

12. A method for processing at least one MGCP packet over a network, comprising the step of:
transmitting said at least one MGCP packet from at least one voice device through an MALG out to a WAN.

13. A method for processing at least one MGCP packet over a network, comprising the step of:
transmitting said at least one MGCP packet from at least one voice device through an MALG, continuing through a DHCP/NAT router out to a WAN.

14. A method for processing at least one MGCP packet over a network, comprising the step of:
transmitting said at least one MGCP packet from at least one voice device on a dedicated voice IP segment through an MALG, continuing through a DHCP/NAT router out to a WAN.

15. A method for processing at least one MGCP packet over a network, comprising the step of:
transmitting said at least one MGCP packet from at least one voice device through an MALG, continuing through a dedicated router out to a WAN.

16. The method of claim 12, 13, 14 or 15, wherein said at least one voice device is an IP phone, a digital phone or an analog phone with a client adapter, or a computer with a VoIP capability.

17. A system for processing at least one MGCP packet over a network, comprising:
at least one physical port for receiving said at least one MGCP packet;
a call control proxy for processing said at least one MGCP packet; and
a mapping device for mapping said at least one MGCP packet from a private IP address field to a public IP address field and a private TID number to a public TID number using an address lookup table.

18. A system for processing at least one MGCP packet over a network, comprising:
at least one physical port for receiving said at least one MGCP packet;
a call control proxy for processing said at least one MGCP packet; and
a mapping device for mapping said at least one MGCP packet from a public IP address field to a private IP address field and a public TID number to a private TID number using an address lookup table.

19. The system of claim 17, wherein said mapping device comprises:
a device which receives said at least one MGCP packet from a LAN comprising said private IP address field, and determines whether a destination route is through an MALG proxy, wherein if said destination route is not through said MALG proxy, then said at least one MGCP packet is dropped;
a device which, if said destination route is through said MALG proxy, then stores said private IP address field and said private TID number in said address lookup table, assigns said public TID number and inserts said public TID number into said address lookup table, replaces said private IP address field with said public IP address field and replaces said private TID number with said public TID number; and
a device for transmitting said at least one MGCP packet to a WAN comprising said public IP address field.

20. The system of claim 18, wherein said mapping device comprises:
a device which receives said at least one MGCP packet from a WAN comprising said public IP address field, and determines whether said public TID number and said mapped private TID number and said mapped private IP address field exists in said address lookup table, wherein if said public TID number or said mapped private TID number or said mapped private IP address field does not exist in said address lookup table, then said at least one MGCP packet is dropped, and
a device which, if said public TIED number or said mapped private TID number or said mapped private IP address field does exist in said address lookup table, then stores said public IP address field and said public TID number in said address lookup table, assigns said private TID number and inserts said private TIED number into said address lookup table, replaces said public IP address field with said private IP address field and replaces said public TIED number with said private TID number; and
a device for transmitting said at least one MGCP packet to a LAN comprising said private IP address field.

21. A system for processing at least one MGCP packet over a network, comprising:
a device which receives said at least one MGCP packet;
a mapping device for mapping said at least one MGCP packet from a private IP address field to a public IP address field and a private TID number to a public TID number using an address lookup table;
a device which scans said at least one MGCP packet to detect an SDP field wherein said SDP field includes at least one private UDP port number for receiving at least one RTP or RTCP packet from a LAN comprising said private IP address field and transmitting said at least one RTP or RTCP packet to a WAN comprising said public IP address field;
a device for binding said private IP address field with said at least one private UDP port number included in said SDP field to a new private UDP port number selected by an MALG, and binding said public IP address field to a new public port number selected by said MALG such that said at least one RTP or RTCP packet can be received via said LAN comprising said private IP address field on said new private UDP port number, and is transmitted on said new public UDP port number via said WAN comprising said public IP address field, and said at least one RTP or RTCP packet can also be received via said WAN comprising said public IP address field on said new public UDP port number, and is transmitted on said new private UDP port number via said LAN comprising said private IP address field; and
a device for unbinding said private IP address field with said at least one private UDP port number included in said SDP field from said new private UDP port number, and unbinding said public IP address field from said new public UDP port number such that said at least one RTP or RTCP packet is not transmitted on said new public and said new private UDP port numbers wherein said new public and said new private UDP port numbers are available for reuse.

22. A system for processing at least one MGCP packet over a network, comprising:
a device which receives said at least one MGCP packet
a mapping device for mapping said at least one MGCP packet from a public IP address field to a private IP address field and a public TID number to a private TID number using an address lookup table;
a device which scans said at least one MGCP packet to detect an SDP field wherein said SDP field includes at least one public UDP port number for receiving at least one RTP or RTCP packet from a WAN comprising said public IP address field and transmitting said at least one RTP or RTCP packet to a LAN comprising said private IP address field;
a device for binding said public IP address field with said at least one public UDP port number included in said SDP field to a new public UDP port number selected by an MALG, and binding said private IP address field to a new private UDP port number selected by said MALG such that said at least one RTP or RTCP packet can be received via said WAN comprising said public IP address field on said new public UDP port number, and is transmitted on said new private UDP port number via said LAN comprising said private IP address field, and said at least one RTP or RTCP packet can also be received via said LAN comprising said private IP address field on said new private UDP port number, and is transmitted on said new public UDP port number via said WAN comprising said public IP address field; and
a device for unbinding said public IP address field with said at least one public UDP port number included in said SDP field from said new public UDP port number, and unbinding said private IP address field from said new private UDP port number such that said at least one RTP or RTCP packet is not transmitted on said new private and said new public UDP port numbers wherein said new private and said new public UDP port numbers are available for reuse.

23. The system of claim 21 or 22, wherein said mapping device maps said at least one MGCP packet within 10 milliseconds (ms) of receiving said at least one MGCP packet comprising at least one said SDP field.

24. The system of claim 21, wherein said mapping device comprises:
a device which receives said at least one MGCP packet from said LAN comprising said private IP address field, and determines whether a destination route is through an MALG proxy, wherein if said destination route is not through said MALG proxy, then said at least one MGCP packet is dropped;
a device which, if said destination route is through said MALG proxy, then stores said private IP address field and said private TID number in said address lookup table, assigns said public TID number and inserts said public TID number into said address lookup table, replaces said private IP address field with said public IP address field and replaces said private TID number with said public TID number; and
a device for transmitting said at least one MGCP packet to said WAN comprising said public IP address field.

25. The system of claim 22, wherein said mapping device comprises:
a device which receives said at least one MGCP packet from said WAN comprising said public IP address field, and determines whether said public TID number and said mapped private TID number and said mapped private IP address field exists in said address lookup table, wherein if said public TID number or said mapped private TID number or said mapped private IP address field does not exist in said address lookup table, then said at least one MGCP packet is dropped, and
a device which, if said public TID number or said mapped private TIED number or said mapped private IP address field does exist in said address lookup table, then stores said public IP address field and said public TID number in said address lookup table, assigns said private TID number and inserts said private TID number into said address lookup table, replaces said public IP address field with said private IP address field and replaces said public TID number with said private TID number; and
a device for transmitting said at least one MGCP packet to said LAN comprising said private IP address field.

26. The system of claim 21 or 24, further comprising a mapping device for mapping said at least one RTP or RTCP packet received from said LAN, comprising:
a device which receives said at least one RTP or RTCP packet from said LAN comprising said private IP address field, stores said private IP address field and a private UDP port number in said address lookup table, and assigns a public UDP port number and inserts said public UDP port number into said address lookup table;
a device which determines whether a destination route is through an MALG proxy, wherein if said destination route is not through said MALG proxy, then said at least one RTP or RTCP packet is dropped, and determines whether a private UDP port number corresponding to said at least one RTP or RTCP packet exists in said address lookup table, wherein if said private UDP port number does not exist in said address lookup table, then said at least one RTP or RTCP packet is dropped; further wherein, if said private UDP port number does exist in said address lookup table, then replaces said private IP address field with a corresponding public IP address field and replaces said private UDP port number with said corresponding public UDP port number from said address lookup table; and
a device for transmitting said at least one RTP or RTCP packet to said WAN comprising said public IP address field.

27. The system of claim 22 or 25, further comprising a mapping device for mapping said at least one RTP or RTCP packet received from said LAN, comprising:
a device which receives said at least one RTP or RTCP packet from said WAN comprising said public IP address field, stores said public IP address field and a public UDP port number in said address lookup table, and assigns a private UDP port number and inserts said private UDP port number into said address lookup table;
a device which determines whether a public UDP port number and a corresponding private UDP port number and a corresponding private IP address exist in said address lookup table, wherein if said public UDP port number or said corresponding private UDP port number or said corresponding private IP address does not exist in said address lookup table, then said at least one RTP or RTCP packet is dropped;
further wherein, if said public UDP port number or said corresponding private UDP port number or said corresponding private IP address does exist in said address lookup table, then replaces said public IP address field from a destination address field with said private IP address field and replaces said public UDP port number with said corresponding private UDP port number; and
a device for transmitting said at least one RTP or RTCP packet to said LAN comprising said private IP address field.

28. The system of claim 21 or 22 further comprising an FTP or a TFTP relay or server.

29. The system of claim 21 or 22 further comprising an NTP relay or server.

30. A system for processing at least one MGCP packet over a network, comprising:
a device for transmitting said at least one MGCP packet from at least one voice device through an MALG out to a WAN.

31. A system for processing at least one MGCP packet over a network, comprising:
a device for transmitting said at least one MGCP packet from at least one voice device through an MALG, continuing through a DHCP/NAT router out to a WAN.

32. A system for processing at least one MGCP packet over a network, comprising:
a device for transmitting said at least one MGCP packet from at least one voice device on a dedicated voice IP segment through an MALG, continuing through a DHCP/NAT router out to a WAN.

33. A system for processing at least one MGCP packet over a network, comprising:
a device for transmitting said at least one MGCP packet from at least one voice device through an MALG, continuing through a dedicated router out to a WAN.

34. The system of claim 30, 31, 32 or 33, wherein said at least one voice device is an IP phone, a digital phone or an analog phone with a client adapter, or a computer with a VoIP capability.
